(19) United States
(12) Patent Application Publication
(10) Pub. No.: US 2009/0288017 A1
(43) Pub. Date: Nov. 19, 2009

(54) Device and Method For Relaying A Massage Instruction

(76) Inventors: Jennifer J. Just, Chicago, IL (US); James T. Just, Mequon, WI (US)

Correspondence Address: QUARLES & BRADY LLP, 411 E. WISCONSIN AVENUE, SUITE 2040, MILWAUKEE, WI, 53202-4497, US

(21) Appl. No.: 12/123,098

(22) Filed: May 19, 2008

(51) Int. Cl. A61G 7/00; G06F 3/00

(52) U.S. Cl. 715/750; 5/600

(57) ABSTRACT

A communication device and method is provided for relaying a massage instruction from a person receiving a massage to a massage therapist. The communication device has an input module and an output module, which may be mounted to a massage table. The person receiving the massage operates a plurality of controls to indicate a massage instruction. The input module transmits data pertaining to the massage instruction to the output module. The output module receives the data pertaining to the massage instruction and indicates the massage instruction to the massage therapist.

### CROSS-REFERENCE TO RELATED APPLICATION

Not applicable.

### STATEMENT OF FEDERALLY SPONSORED RESEARCH OR DEVELOPMENT

Not applicable.

### BACKGROUND OF THE INVENTION

The present invention relates to devices and methods for relaying instructions. In particular, this invention relates to a devices and methods for relaying massage instructions.

Massage therapy has become an increasingly popular method of relieving stress and improving health. During a typical massage, a massage therapist physically manipulates another's body with various types of mechanical pressure to relieve tension in areas such as the muscles and connective tissues.

In addition to relieving purely physical tension, massage therapy may provide significant benefits for mental health. A physically relaxed body is less prone to mental stresses that may result in, for example, depression or anxiety. Thus, massage has been perceived to be, and is often marketed as, a calming and relaxing experience. Massage therapy is frequently offered at locations such as health spas, which desire to create a warm, welcoming atmosphere by providing comfortable surroundings.

For various reasons, the person receiving the massage may not want or be able to converse with the individual providing the massage. Perhaps, the person receiving the massage is in a position that makes it difficult to provide massage instructions, such as in a face-down position with portions of the face restricted by the massage table. The person receiving the massage may be immersed in the surrounding sounds or wearing headphones. The person receiving or providing the massage may be mute, deaf, or speak different languages, making it difficult to convey the instruction. In some cases, it just may be uncomfortable to talk to the person providing the massage for interpersonal reasons.

To remove the reliance on and, at least in part, the need for oral communication with a massage therapist, various mechanical devices have been developed to mimic the action of a massage therapist. See e.g. U.S. Pat. No. 6,585,668 and U.S. Pat. Pub. 2006/0282026. For example, the '668 patent discloses a massage machine in which a user can input a massage instruction into the machine. Then, an arm with a massaging robot hands is craned over the back of the user. The massaging robot hands are lowered down to the body and begin to massage the user.

Such machines, while eliminating the need for a massage therapist, may generate substantial noise due to mechanical movement, thus lessening the relaxing quality of the massage. Further, the risk of the device failure during operation might make some individuals reluctant to use it.

Thus, there is a need for a way to provide the quality of massage similar to the one provided by a massage therapist, without the person receiving the massage being required to speak to a massage therapist.

### SUMMARY OF THE INVENTION

The present invention provides a device and method for relaying a massage instruction that does not require the person receiving the massage to speak to the massage therapist. The person receiving the massage can input massage instructions into one module, which then relays the massage instructions another module that presents the instructions to the massage therapist. In this way, a massage instruction can be relayed from a person receiving a massage to the massage therapist without requiring speech between the two individuals.

A communication device is provided for relaying a massage instruction from a person receiving a massage to a massage therapist. The communication device includes an input module and an output module. The input module has a plurality of controls that generate data pertaining to the massage instruction and transmits this data to the output module. The output module receives this data and indicates the massage instruction such that the massage instruction can be observed by the massage therapist. In one form, the invention includes a massage table that supports the person receiving the massage and permits the mounting of at least one of the input and output module.

A method is also provided for relaying a massage instruction from a person receiving a massage to a massage therapist. The method includes providing an input module having a plurality of controls to the person receiving the massage, inputting the massage instruction to the input module, transmitting the massage instruction from the input module to the output module, and outputting the massage instruction to the output module such that the massage instruction is provided to the massage therapist. At this point, the massage therapist may massage the person receiving the massage according to the massage instruction.

Variations may be made to the invention. For example, the plurality of controls on the input module may include a body zone indicator, a directional indicator, and a pressure indicator. The input module may be a touch screen that responds to tactile contact. At least one of the input and output modules may provide a visual feedback that may use a color system to indicate the intensity of the massage instruction. Moreover, the data transmission from the input module to the output module may be either via a data cable or wireless transmitter/receiver combination. It is possible that the output module will either display the massage instruction on a display screen or audibly provide the massage instruction.

These and other advantages of the present invention will be apparent from the description below and the accompanying drawings. While a preferred embodiment is described and depicted, it should be understood that this disclosure is not made by way of limitation.

### BRIEF DESCRIPTION OF THE DRAWINGS

It should be understood that the drawings are provided for the purpose of illustration only and are not intended to define the limits of the invention. The present invention is not limited to the precise arrangements and instrumentalities shown in the drawings, and the drawings are not necessarily to scale, emphasis instead being placed upon illustrating the principles disclosed herein, wherein:

FIG. 1 is a view of the device for relaying a massage instruction showing a person laying on a massage table;

FIG. 2 is a view of the device shown in FIG. 1, but with the arm of the touch screen adjusted such that the person can see and operate the input module while his head is in the head rest;

FIG. 3 is a detailed view of an input module; and

FIG. 4 is a detailed view of an output module.

### DETAILED DESCRIPTION OF THE PREFERRED EMBODIMENT

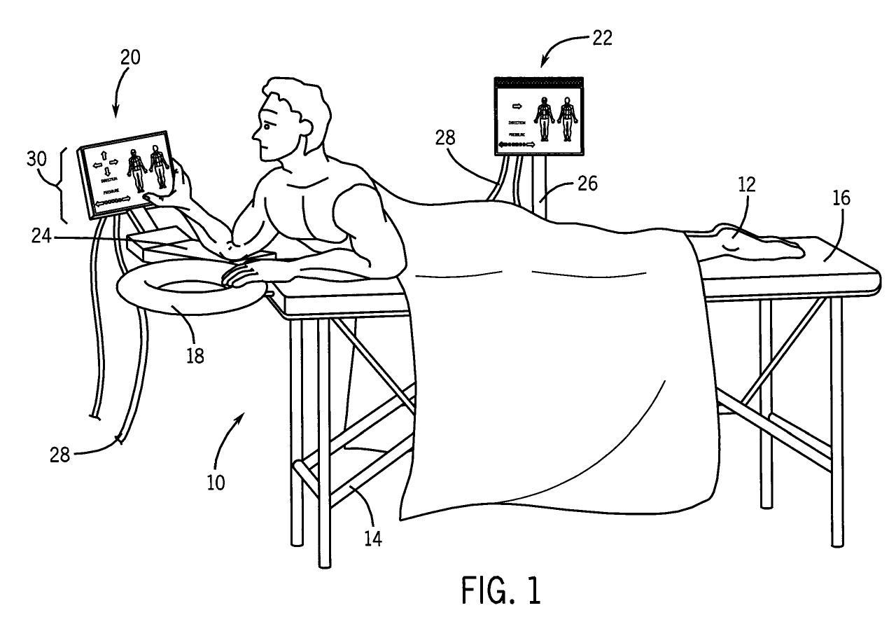

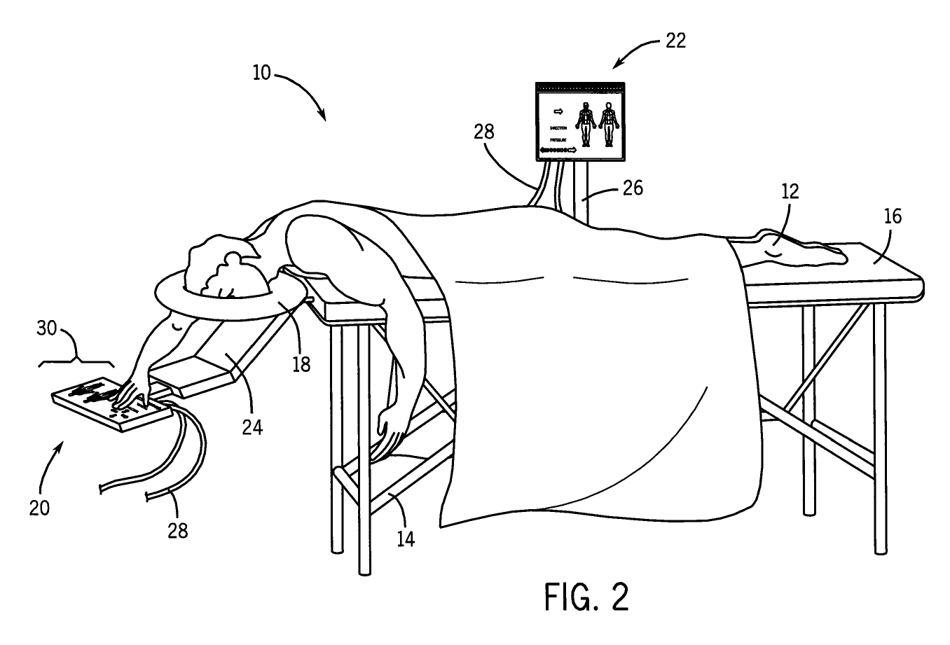

Referring first to FIGS. 1 and 2, a massage table 10 is shown with a person 12 receiving a massage laying thereupon. The massage table 10 has a frame 14, a surface 16, and, optionally, a head rest 18. The frame 14 may be either moveable, as may be the case in a collapsible massage table, or fixed, as may be found in an stationary massage table. The surface 16 may be any surface suitable for holding all or a portion of a human body and may or may not include cushioned sections. A head rest 18 may provide support for the head or neck of the person receiving the massage such that he or she may lie face down and still have support for his or her head and comfortably breath.

A communication device including an input module 20 and an output module 22 is attached to the massage table 10. The input module 20 is attached to the massage table 10 by an arm 24. The arm 24 is adjustable, such that the location of the input module 20 may be altered to most comfortably be operated by the person receiving the massage, regardless of his or her size or stature. As can be seen in FIG. 2, arm 24 may be adjustable such that the input module 20 is both visible and controllable by the person 12 when the person 12 has his or her head in the head rest 18. Likewise, an output module 22 is attached to the massage table 10 by a bracket 26 or other connector, which may be fixed or moveable. The input module 20 is linked to the output module 22 by a data cable 28. In the case where the output module 22 has a display screen, the output module 22 can be placed in any location at which the massage therapist can see the massage instruction.

It should be appreciated that although the input module 20 and the output module 22 are shown as being directly attached to the massage table 10, that the input module 20 and the output module 22 do not need to be directly attached to the massage table 10. For instance, the input module 20 may be a hand-held unit that communicates wirelessly with an output module 22 mounted on a nearby wall. Thus, it is contemplated that the units may be linked by the data cable 28 or wirelessly via a wireless transmitter and receiver as is known to those skilled in the art of communication devices.

Likewise, the output module 22 does not need to be mounted directly to the massage table 10. If the output module 22 incorporates visual elements, it can be positioned at a location where the massage therapist can easily see the output module 22. If the output module 22 only incorporates audible elements, then there may be more flexibility in the positioning of the output module 22.

The person 12 receiving the massage inputs massage instructions into a plurality of controls 30 on the input module 20. The input module 20 generates data pertaining to the massage instruction and transmits this data to the output module 22 which receives the data. This transmission and receiving of data may occur via either the data cable 28 or wirelessly. In the case of wireless transmission, the input module 20 would have a wireless transmitter and the output module 22 would have a wireless receiver. The output module 22 outputs the massage instruction such that the massage instruction is provided to the massage therapist. The massage therapist then may massage the person 12 receiving the massage according to the massage instruction.

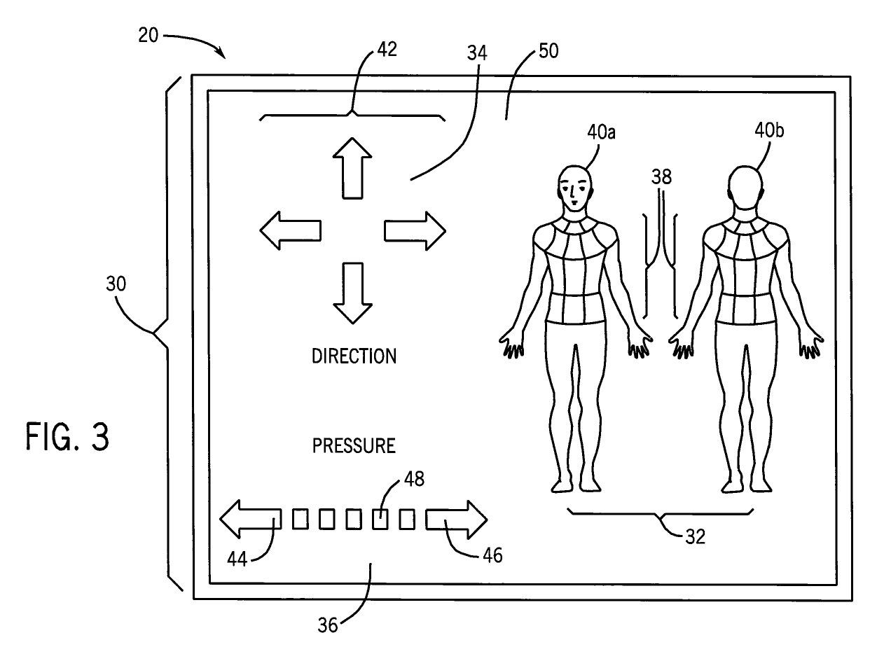

Now referring to FIG. 3, a detailed view of the input module 20 is shown. The input module 20 includes the plurality of controls 30 including a body zone indicator 32, a directional indicator 34, and a pressure indicator 36.

The body zone indicator 32 includes a plurality of zones 38 on a front half of a body 40a and a back half of a body 40b. The person 12 may select one or more of the plurality of zones 38 to indicate the region of the body that he or she would like to be massaged. The plurality of zones 38 shown may be based on criterion such as, for example, the location of muscle groups and bones. Although a grid of zones may be provided as shown, it is contemplated that a “gridless” or point selection of a location on the bodies 40a and 40b might be made. Moreover, it is contemplated that only a single side of the body may be shown on the input module 20.

The directional indicator 34 includes a plurality of directional arrows 42 to indicate a direction in which the person receiving the massage would like the massage therapist to move the massaging action. The directional indicator 34 may be used in conjunction with the body zone indicator 32 to finely indicate a region of the body.

A pressure indicator 36 includes at least two controls 44 and 46 to indicate an desired increase or decrease in the pressure to be applied during the massage. There may exist a segmented or continuous spectrum 48 that indicates the relative increase or decrease in pressure desired.

The input module 20 has a touch screen 50 that responds to tactile contact. Upon touching the screen 50, the screen 50 may provide a visual feedback. For instance, if a body zone 38 is indicated, the body zone 38 that is selected may change to a different color.

Although a touch screen 50 is shown on the input module 20, it is contemplated that other common controls may be used to provide input to the input module 20. For example, mechanical and/or electrical buttons or switches may be used as controls.

Both the input module 20 and the output module 22 may provide visual feedback about the massage instruction to the person 12 receiving the massage and the massage therapist. For example, when the pressure indicator 36 is adjusted by the person 12 receiving the massage, the intensity blocks 48 of the pressure indicator 36 may change to indicate the selected pressure on one of or both of the input module 20 and the output module 22. The selection may also be indicated by use of a color system. For example, a high pressure selection may be indicated by a dark red color, while a low pressure selection may change the color of the pressure indicator to blue. Selections in the intermediate range may include a combination of the two colors. In this way, the intensity of the selection can be determined by a quick glance of the massage therapist.

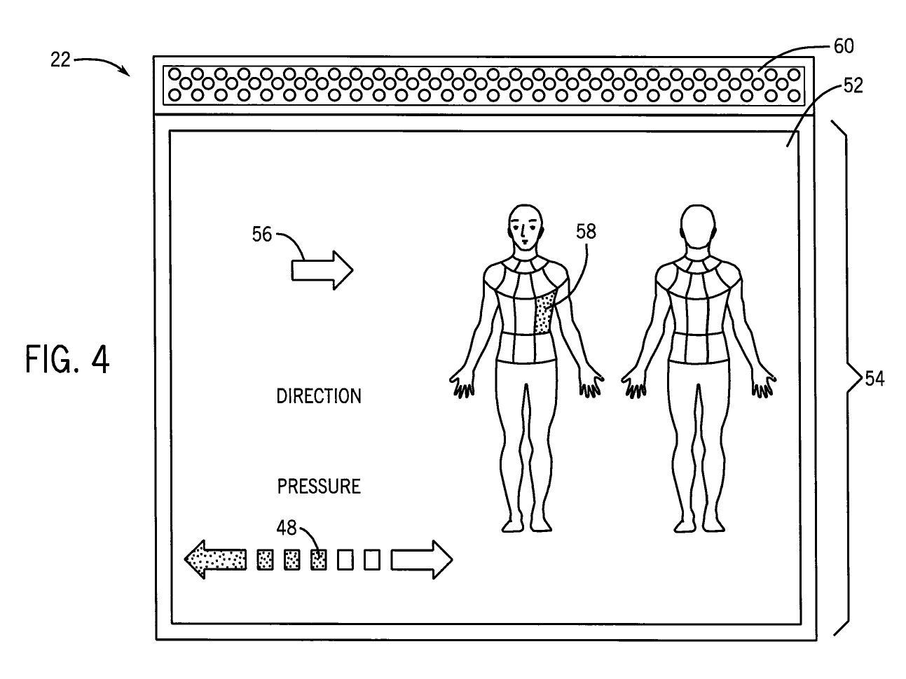

Now referring to FIG. 4, a detailed view of the output module 22 is shown. A display 52 on the output module 22 is similar to the input module 20 and provides visual feedback to the massage therapist. As shown, the plurality of controls 30 on the input module 20 have a corresponding plurality of indicators 54 on the output module 22. Although the display 52 of the output module 22 could mirror the display 50 of the input module 20, the output module 22 is shown as displaying selected values for the massage instruction. For example, the direction indicator 56 indicates that a rightward selection has been selected, and does not show the other three directions as on the input module 20, unless one of them has been selected. As yet another example, a selected body zone 58 is shown on the body zone indicator on the output module 22.

Additionally, the output module is shown as having a speaker 60 for providing an audible message. However, any means for providing an audible message may be used. This speaker 60 can audibly provide the massage instruction, such that the massage therapist can hear the instruction, even if he or she cannot see the output module 22. It is contemplated that having a means for providing an audible message may be preferred in cases in which the person 12 receiving the massage is unable to speak, either because of disability or because of the difficulty of clearly speaking when facing downward on the massage table 10. Thus, it is possible that the output module 22 may include one of or both of the display 52 or the speaker 60 to provide the massage instruction to the massage therapist.

Thus, the present invention provides a device and method of relaying a massage instruction that does not require verbal communication between the person receiving a massage and the massage therapist. The person receiving the massage can provide real-time instructions via the communication device to the massage therapist to indicate the desired massage action. In this way, a massage can be performed by the massage therapist—having the high quality of a massage performed by a human—without requiring the interpersonal interaction typically required as the massage is being performed.

While several embodiments have been described and disclosed, it will be apparent to those skilled in the art that other changes can be made as well. Therefore, the present invention is not to be limited to just the described most preferred embodiments. Hence, to ascertain the full scope of the invention, the claims which follow should also be referenced.

I claim:

1. A communication device for relaying a massage instruction from a person receiving a massage to a massage therapist, the communication device comprising:
an input module, the input module having a plurality of controls that generate data pertaining to the massage instruction and transmitting the data from the input module; and
an output module, the output module receiving the data pertaining to the massage instruction and indicating the massage instruction such that the massage instruction can be observed by the massage therapist;
wherein a person receiving a massage uses the input device to provide a massage instruction to the output module such that a massage therapist can receive the massage instruction.

2. The communication device of claim 1 further comprising a massage table for supporting the person receiving the massage, at least one of the input module and the output module being mounted to the massage table.

3. The communication device of claim 2 wherein the massage table further comprises a head rest with an aperture extending therethrough and the input module may be positioned such that the person receiving the massage can see and operate the input module through the aperture while a head of the person is received in the head rest.

4. The communication device of claim 3 wherein the massage table further comprises an arm connecting the input module to the massage table.

5. The communication device of claim 1 wherein the plurality of controls includes a body zone indicator.

6. The communication device of claim 1 wherein the plurality of controls includes a directional indicator.

7. The communication device of claim 1 wherein the plurality of controls includes a pressure indicator.

8. The communication device of claim 1 wherein the input module has a touch screen that responds to a tactile contact of the person receiving the massage.

9. The communication device of claim 1 wherein at least one of the input module and the output module provides a visual feedback.

10. The communication device of claim 9 wherein at least a portion of the visual feedback uses a color system to indicate an intensity for the massage instruction.

11. The communication device of claim 1 further comprising a data cable;
wherein transmitting of the data from the input module to the output module occurs via the data cable.

12. The communication device of claim 1 further comprising a wireless transmitter in the input module and a wireless receiver in the output module;
wherein transmitting of the data from the input module to the output module occurs via a wireless transmission from the wireless transmitter to the wireless receiver.

13. The communication device of claim 1 further comprising a display screen on the output module;
wherein the display screen displays the massage instruction on the display screen such that the massage therapist can see the massage instruction.

14. The communication device of claim 1 further comprising a means for providing an audible message on the output module;
wherein the means for providing an audible message on the output module provides the massage instruction in an audible form.

15. A method of relaying a massage instruction from a person receiving a massage to a massage therapist, the method comprising the steps of:
providing an input module having a plurality of controls to the person receiving a massage;
inputting the massage instruction to the input module;
transmitting the massage instruction from the input module to an output module; and
outputting the massage instruction to the output module such that the massage instruction is provided to the massage therapist.

16. The method of claim 15 further comprising the step of the massage therapist massaging the person receiving the massage according to the massage instruction.

17. The method of claim 15 wherein the plurality of controls includes a body zone indicator.

18. The method of claim 15 wherein the plurality of controls includes a directional indicator.

19. The method of claim 15, wherein the plurality of controls includes a pressure indicator.

20. The method of claim 15 wherein the input module is a touch screen responsive to a tactile contact of the person receiving the massage.

21. The method of claim 15 wherein the at least one of the input module and the output module provides a visual feedback.

22. The method of claim 21 wherein at least a portion of the visual feedback uses a color system to indicate an intensity of the massage instruction.

23. The method of claim 15 wherein the transmitting of the massage instruction from the input module to the output module occurs via a data cable.

24. The method of claim 15 wherein the transmitting of the massage from the input module to the output module occurs via a wireless transmission.

25. The method of claim 15 wherein the output module displays the massage instruction on a display screen.

26. The method of claim 15 wherein the output module provides the massage instruction in an audible form.
